(19) United States
(12) Patent Application Publication
(10) Pub. No.: US 2017/0071033 A1
(43) Pub. Date: Mar. 9, 2017

(54) HEATING DEVICE FOR FLUIDS AND METHOD FOR MANUFACTURING SUCH A HEATING DEVICE

(71) Applicant: TÜRK & HILLINGER GMBH, Tuttlingen (DE)

(72) Inventor: Andreas SCHLIPF, Tuttlingen (DE)

(21) Appl. No.: 15/196,689

(22) Filed: Jun. 29, 2016

(30) Foreign Application Priority Data
Sep. 4, 2015 (DE) 10 2015 114 886.2

(51) Int. Cl. H05B 3/48; H05B 3/52; H05B 1/02

(52) U.S. Cl. CPC H05B 3/48; H05B 1/0297; H05B 1/0205; H05B 1/0213; H05B 3/52; H05B 2203/021; H05B 2203/017

(57) ABSTRACT

A method and a heating device (100, 200, 300, 400, 500, 600, 700, 800, 900, 1000, 1100) for fluids are provided. The device includes a tubular metal jacket (101, 201, 301, 401, 501, 601, 701, 801, 901, 1001, 1101), a heating element (102, 202, 302, 312, 402, 502, 602, 702, 802, 902, 1002, 1102) and a control/regulating element (103, 203, 303, 403, 420, 503, 620, 720, 803, 903, 1003, 1103) for the heating element. The heating element and the control/regulating element are arranged at least partially within the tubular metal jacket and are embedded at least partially in a metal powder or granular metal (109, 209, 309, 409, 509, 609, 709, 809, 909, 1009, 1109) within the jacket. The heating element is a heating cartridge, a hollow cartridge, a tubular heating body or a coiled tube cartridge. The control/regulating element is electrically insulated from the metal powder or granular metal.

### CROSS REFERENCE TO RELATED APPLICATIONS

This application claims the benefit of priority under 35 U.S.C. §119 of German Application 10 2015 114 886.2 filed Sep. 4, 2015 the entire contents of which are incorporated herein by reference.

### FIELD OF THE INVENTION

The present invention pertains to a heating device for fluids, which has a tubular jacket surface formed of metal, at least one heating element and at least one control and/or regulating element (control/regulating element) for the at least one heating element, wherein the at least one heating element and the at least one control and/or regulating element are arranged at least partially within the tubular jacket surface formed of metal and are embedded at least partially in a powder or granular material present within the tubular jacket surface formed of metal, and to a method for manufacturing a heating device.

### BACKGROUND OF THE INVENTION

Heating devices for fluids are generally known to be in the form of electric heating cartridges with a control and/or regulating element (control/regulating element). The problem arising in such heating devices is basically that it must be ensured that the temperature, to which the control and/or regulating element is exposed, is as identical as possible to the temperature of the heating device at any time, because a timely intervention of the control or regulating mechanism and especially a timely switching off of the heating device can thus be guaranteed. However, this ideal is not achieved, in practice, so that different temperatures, which lead to a response characteristic that is delayed in time, are present, at least temporarily, at the control and/or regulating element, on the one hand, and at the heating device, on the other hand.

In addition, it is problematic that the prior-art heating cartridges have an insulation packing, which must, as a rule, be subjected to a compaction process during their manufacture, during which the pressures that must be applied are so high that the sensitive control and/or regulating element may become damaged.

It is known from DE 20 2008 014 050 U1 that this problem can be circumvented in case of a joint arrangement of the control and/or regulating element and the heat conductor in the insulation packing by compaction being carried out at different intensities, which is sufficiently weak in the sections of the heating cartridge in which control and/or regulating elements are arranged to avoid the risk of damage to the control and/or regulating element.

The drawback of this procedure is that the necessity to achieve accurate, location-dependent compaction leads to a high manufacturing effort.

An alternative approach is known from DE 299 20 503 U1. It is proposed there that the control and/or regulating element be provided axially outside the insulation packing and that a heat-conducting tube be provided, which extends over the metal jacket of the electric heating cartridge and in the cavity of which, which is optionally filled by casting, the control and/or regulating element is arranged.

The drawback of this arrangement is that experience has shown that the heat transport that can be achieved in this way is not sufficient, so that, in particular, a prompt response of the control and/or regulating element is no longer guaranteed.

### SUMMARY OF THE INVENTION

An object of the present invention is consequently to provide a regulated heating device for fluids, which can be manufactured in an uncomplicated manner and in which a prompt response of the control and/or regulating element (control/regulating element) is guaranteed.

The electric heating device according to the present invention for fluids has a tubular jacket surface formed of metal (i.e., a jacket tube consisting of metal—a tubular metal jacket), at least one heating element and at least one control and/or regulating element for the at least one heating element, wherein the at least one heating element and the at least one control and/or regulating element are arranged at least partially within the tubular jacket surface consisting of metal and are embedded at least partially in a powder or granular material present within the tubular jacket surface consisting of metal.

An at least partial embedding in the powder or granular material is defined, in addition to a partial embedding in the longitudinal direction, in which case one section is not embedded, especially also as a partial embedding in the radial direction, in which case the path from the control and/or regulating element to the tubular jacket surface consisting of metal has sections in which the path passes through this powder or granular material and has sections in which it passes through another material, e.g., a powder or granular material possessing different properties.

The control and/or regulating element is used here especially to monitor the temperature. In particular, this term shall also cover sensors, whose measured values are processed by a control arranged outside the electric heating device and are converted into monitoring, control or regulating signals.

In the sense of this patent, the word “tubular” implies any desired cross section, which may also vary in the direction in which the tube extends, i.e., especially circular, rectangular and conically extending cross sections. The tubular jacket surface may also be part of a dummy pipe, i.e., of a pipe with a surface closing its passage.

It is essential for the present invention that at least one heating element is a heating cartridge, a hollow cartridge, a tubular heating element or a coiled tube cartridge, that the powder or granular material is a metal powder or granular metal, and that the at least one control and/or regulating element is electrically insulated from the metal powder or granular metal.

The use of an electric heating element, which use is actually remote because the metal jacket forms the outer surface of the electric heating device anyway, wherein the outer surface of the heating element is formed essentially by a metal jacket, i.e., a metal jacket that is present in addition to the surface of the electric heating device, which implies, in particular, that a heating device is a heating cartridge, a hollow cartridge, a tubular heating element or a coiled tube cartridge, makes it possible in this arrangement to use a metal powder or granular metal as a filler for the metal jacket of the electric heating device.

The development studies have surprisingly shown that because of the joint arrangement of the heating element and a control and/or regulating element electrically insulated against the area surrounding it in a metal powder or granular metal, it can be ensured even without compaction that good heat transfer and short response times are guaranteed. Because of the at least partial embedding of the heat-conducting sleeve in the metal powder or granular metal, heat losses, as they occur in the state of the art, especially in DE 299 20 503 U1, are ruled out, and good heat transfer to the control and/or regulating element is guaranteed, which leads to short response times. As is usual in most cases, the term “metal” also covers, in the sense of this specification, not only pure, elemental metals, but also alloys and intermetallic compounds, especially those in which a metallic bond is present between the constituent atoms.

According to a preferred variant of the present invention, the at least one control and/or regulating element is insulated from the metal powder or granular metal by the at least one control and/or regulating element being arranged within a sleeve, which is likewise arranged at least partially within the tubular jacket surface consisting of metal and is at least partially embedded in the metal powder or granular material present within the first jacket surface consisting of metal.

The sleeve may also be formed, for example, by an insulating tube section or insulating tubing, which may be manufactured especially from Teflon, PTFE, glass silk fabric or a polyimide.

This sleeve is then preferably filled with a powder or granular material, e.g., MgO, which possesses electrically insulating but good heat-conducting properties, which makes it possible to use control and/or regulating elements with electrically conducting parts on the outer side thereof. Other advantageous fillers for the sleeve are, for example, epoxy resin or silicone rubber. The control and/or regulating element can also be permanently embedded in the sleeve by casting with these alternative fillers.

As an alternative, the use of such control and/or regulating element may, however, also be made possible by surrounding the control and/or regulating element with an electrically con-conducting sleeve, which may be formed, e.g., by a heat-shrinkable sleeve.

At the same time, the sleeve represents a shield for the pressure-sensitive control and/or regulating element against the pressure occurring during the compaction, so that the entire arrangement can even be compacted without there being a drastically increased risk of failure because of a possible damage to the control and/or regulating element. Due to the sleeve being provided, lower compaction of the powder or granular material can automatically be achieved during a compaction in the area in which the control and/or regulating element is embedded.

It must be ensured, especially because of the surrounding area, which is formed by the metal powder or granular metal, being conducting, that the control and/or regulating element is electrically insulated in relation to this surrounding area. This can be achieved by the use of a sleeve consisting of an electrically insulating material, which does, however, preferably have good heat conduction, optionally with the use of a cover and/or bottom plate consisting of the same material, but, as an alternative or in addition, also by embedding the control and/or regulating element in electrically insulating filler, especially MgO, which does, however, preferably possess good thermal conduction, in the space within the sleeve.

The suitable, electrically non-conducting materials include especially MgO, ceramic compound, e.g., a cement, silicone rubber casting compound or epoxy resin. Molded parts made of plastic, rubber, silicone, Teflon or micanite may also be used.

Various metal powders or granular metals may be used, aluminum or copper being preferred. The material of which the sleeve consists is preferably a metal, especially copper.

In an especially preferred embodiment of the heating device, the sleeve is adapted to the shape of the heating element such that it is in contact with a surface of the heating element at least in some sections. The direct introduction of heat from the heating element into the sleeve, which results from this, leads to an especially short response time.

It is especially advantageous if there is a flat, direct contact between the heating element and the sleeve, which can be guaranteed especially by the sleeve extending around the surface of the heating element at least in some sections and is especially flatly in contact on a section of the outer jacket of the heating cartridge acting as a heating element, hollow cartridge or coiled tube cartridge or of the tubular heating element acting as a heating element.

The outer surface of the sleeve should be located at the greatest possible distance from the inner side of the tubular jacket surface of the electric heating device, because the heat transfer is, as a rule, poorer through the electrically insulating powder or granular material arranged in the interior space of the sleeve at equal compaction than in case of heat transfer through metal powder or granular metal, and a greater distance from the inner side of the tubular jacket surface reduces the volume in which the material having poorer thermal conduction is present.

The at least one control and/or regulating element is preferably configured as a fuse, platinum measuring resistor, NTC (Negative Temperature Coefficient) thermistor, bimetallic release or as a combination of these elements. It should be noted, in general, that the term control and/or regulating element also covers in the sense of this specification components that represent only a component of a controlling or regulating device.

In an advantageous variant of the present invention, the sleeve is adapted, at least in some sections, to the outer contour of the control and/or regulating element. This is especially advantageous when the control and/or regulating element is highly sensitive, so that the homogeneity and sufficient thermal conductivity of an electrically insulating insulation material, in which it is embedded, cannot be guaranteed. By transforming an electrically insulating sleeve into an exactly predefinable shape, the need to subject the control and/or regulating element to a pressure in the manufacturing process can be eliminated in the first place.

The heating device may, in particular, be uncompacted, but it nevertheless has a rapid response characteristic. As an alternative to such a completely uncompacted heating device, provisions are, however, made in a preferred embodiment of the present invention for the heating device to have, in the axial direction, at least one section, in which a cross section through the tubular jacket extends, extends through both compacted areas and uncompacted areas or through areas with different degrees of compaction. The compacted areas may be formed, in particular, by sections of a heating element already compacted to the desired extent in the form of a heating cartridge, hollow cartridge or coiled tube cartridge. The uncompacted areas may then be formed especially by an uncompacted metal powder or granular metal only filled into the remaining interior space of the metal jacket.

The method according to the present invention for manufacturing such an electric heating device has at least the steps of
providing at least one heating element in the form of a heating cartridge, hollow cartridge or coiled tube cartridge,
providing a control and/or regulating element, which is electrically insulated against the area surrounding it,
positioning at least sections of the heating element and of the control and/or regulating element in the interior of a tubular jacket surface consisting of metal, and
filling the inner volume of the tubular jacket surface consisting of metal with a metal powder or granular metal.

The order in which the steps are carried out is preset only in the sense that the particular components to be positioned must, of course, be provided before the positioning and the positioning of the components must take place prior to the filling of the inner volume of the tubular jacket surface consisting of metal or of the tube jacket consisting of metal. The positioning step may also be split, so that the particular assembly unit provided may then also be positioned before the next assembly unit is provided.

The heating element provided is preferably already compacted as desired.

According to a preferred variant of the method, provisions are made for the control and/or regulating element to be insulated against the area surrounding it by being arranged in the interior space of a sleeve such that the control and/or regulating element is electrically insulated against the outer sides of the sleeve.

The control and/or regulating element can be provided such that it is arranged in the interior space of a sleeve such that the control and/or regulating element is electrically insulated against the outer sides of the sleeve especially by using an electrically insulated sleeve without filler, which sleeve is then adapted, preferably by press forming, such that it is adapted to the outer contour of the control and/or regulating element. While the application of pressure to the control and/or regulating element is avoided to the greatest extent possible, the unfilled inner volume of the electrically insulating sleeve can be minimized as a result, which improves the response characteristic of the control and/or regulating element especially in case of temperature monitoring.

As an alternative, the control and/or regulating element, which is arranged in the interior space of a sleeve such that the control and/or regulating element is electrically insulated against the outer sides of the sleeve, may also be provided by the control and/or regulating element being arranged in the interior space of the sleeve and the remaining interior space being then filled with electrically insulating material, for example, with an electrically insulating powder or granular material, e.g., one consisting of MgO. A cautious, controlled compaction may then optionally also be carried out, especially in the latter case, in order to guarantee permanent embedding of the control and/or regulating element.

A third possibility of providing a control and/or regulating element, which is arranged in the interior space of a sleeve such that the control and/or regulating element is electrically insulated against the outer sides of the sleeve, is to arrange the control and/or regulating element in the interior space of the sleeve and then filling the remaining interior space with a casting compound, especially with a casting compound in the form of epoxy resin or silicone rubber.

For control and/or regulating elements that are arranged at electric terminals of the electric heating element, it is advantageous to establish the electric connection between the corresponding electric terminal and the control and/or regulating element before positioning in the interior of the tubular jacket surface consisting of metal.

It may be advantageous in this connection, in particular, to establish this electric connection, then to pull the sleeve over the control and/or regulating element and to subsequently minimize the remaining inner volume either by forming the sleeve or by filling with an electrically insulating material in order to thus ensure that the control and/or regulating element is arranged in the interior space of a sleeve such that it is electrically insulated from the outer side of the sleeve in such a form that is also electrically connected to the electric heating element. The sleeve can then optionally also be connected to a closing plate.

The present invention will be explained in more detail below on the basis of drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a sectional view of a first exemplary embodiment of a heating device;

FIG. 2 is a sectional view of a second exemplary embodiment of a heating device;

FIG. 3 is a sectional view of a third exemplary embodiment of a heating device;

FIG. 4 is a sectional view of a variant of the exemplary embodiment from FIG. 1 with an additional control and/or regulating element;

FIG. 5 is a sectional view of a variant of the arrangement of the control and/or regulating element at the ends of the heating element, which variant is applicable to the exemplary embodiments according to FIGS. 1 through 4;

FIG. 6 is a sectional view of a sixth exemplary embodiment of a heating device;

FIG. 7 is a sectional view of a seventh exemplary embodiment of a heating device;

FIG. 8 is a sectional view of an eighth exemplary embodiment of a heating device;

FIG. 9 is a sectional view of a ninth exemplary embodiment of a heating device;

FIG. 10 is a sectional view of a tenth exemplary embodiment of a heater; and

FIG. 11 is a sectional view of an eleventh exemplary embodiment of a heating device.

### DESCRIPTION OF THE PREFERRED EMBODIMENTS

Referring to the drawings, identical reference numbers are used for identical components of the same exemplary embodiments in all figures.

FIG. 1 shows a sectional view of a first exemplary embodiment of a heating device 100. A tubular jacket surface 101 configured as a cylindrical dummy pipe is seen. A heating element 102 bent in a U-shaped manner, embodied here as a tubular heating body, and two control and/or regulating elements (control/regulating elements) 103, which are connected via contact points 104 on one side to electric terminals 105 of the heating element 102 and on the other side to connection lines 106, are arranged within the tubular jacket surface 101.

The control and/or regulating elements 103 are arranged each individually in a respective sleeve 107, which is preferably configured as a copper pipe. It is, however, also possible to arrange a plurality of control and/or regulating elements 103 in a common sleeve 107, in which case it is irrelevant whether the corresponding control and/or regulating elements 103 are connected to the same or different electric terminals 105 of the heating element 102.

The sleeves 107 are configured in the embodiment being shown such that they are in contact by one section with the surface of the heating element 102, enclosing the latter. Due to the control and/or regulating element 103 being arranged within the sleeves 107, damage to the control and/or regulating elements 103 is avoided even in case of a high compaction and rapid response of the control and/or regulating elements 103 is achieved.

The heating element 102, the control and/or regulating elements 103 and the sleeves 107 are all embedded in a powder or granular material, and it should be noted that different powders or granular materials are involved, which it also recognized from the circumstance that the powder or granular material 108 is represented by a different shading in the area within the sleeves 107 than the powder or granular material 109 in the area outside the sleeves 107. Outside the sleeves 107 and the tubular jacket of the tubular heating body 102, there is a metal powder or granular metal 109 to guarantee good heat transport to the control and/or regulating elements 103 and to keep the response time of said control and/or regulating elements low even without compaction or with slight compaction of the electric heating cartridge 100.

By contrast, an electrically insulating filler, which may be configured especially as an MgO powder or granular MgO, is provided within the sleeves 107.

To guarantee strain relief of the contact points 104, the sleeves 107 are equipped each with optional closing plates 110, through which the connection lines 106 are led, and an additional optional closing plate 111, through which the connection lines 106 are likewise led, is provided for closing the dummy pipe. Further, an optional cover plate 112, with which a container, not shown, in which the heating device 100 shall be arranged, can be closed, is also provided on the side of the heating device 100 on which the connection lines 106 exit.

The exemplary embodiment of the heating device 200 according to FIG. 2 with tubular jacket surface 201, heating element 202 bent in a U-shaped pattern, control and/or regulating elements 203, contact points 204, electric terminals 205, connection lines 206, sleeves 207, MgO powder or granular MgO 208, metal powder or metal granules 209, closing plates 210, 211 and cover plate 212 differs from the exemplary embodiment according to FIG. 1 only in that the sleeves 207 are arranged only partially within the tubular jacket surface 201 and pass through the optional closing plate 211. A shorter type of construction of the heating device 200 can be obtained hereby if it is essential for the heating device 200 to be able to provide good heating output in its area located opposite the connection lines 206 as well.

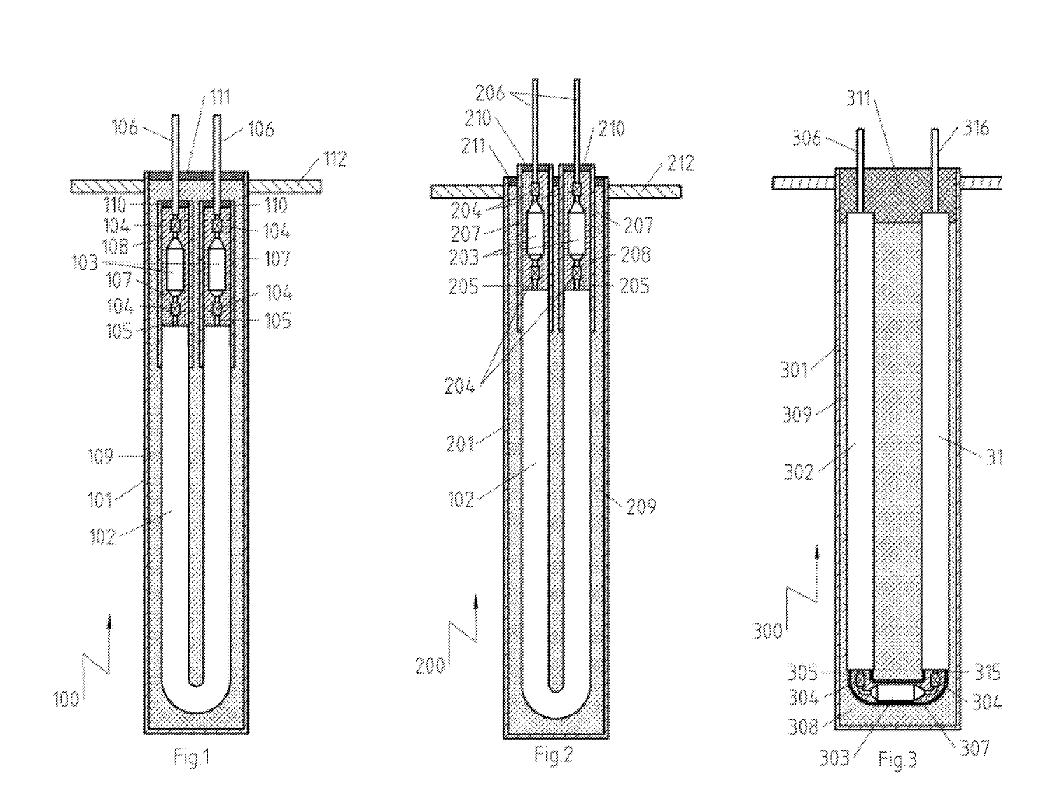

The exemplary embodiment of the heating device 300 according to FIG. 3 with tubular jacket surface 301, heating elements 302, 312, control and/or regulating element 303, contact points 304, electric terminals 305, 315, connection lines 306, 316, sleeve 307, MgO powder or granular MgO 308, metal powder or granular metal 309, closing plate 311 and cover plate 317 differs from the exemplary embodiment according to FIG. 1 only in that the control and/or regulating element 303 is arranged on the side of the heating device 300 located opposite the connection lines 306, 316 within the jacket surface 301 thereof and connects the two heating elements 302, 312 configured as tubular heating bodies. This embodiment is likewise very compact and has the advantage over the embodiment shown in FIG. 2 that the sleeve 307, which is hot during the operation, does not project out of the jacket surface 301.

The exemplary embodiment of the heating device 400 according to FIG. 4 with tubular jacket surface 401, heating element 402 bent in a U-shaped pattern, control and/or regulating elements 403, contact points 404, electric terminals 405, connection lines 406, sleeves 407, MgO powder or granular MgO 408, metal powder or granular metal 409, closing plates 410, 411 and cover plate 412 differs from the exemplary embodiment according to FIG. 2 only by an additional control and/or regulating element 420, which is arranged within a sleeve 421, which is closed with a closing plate 422, and is electrically insulated from the metal powder or granular metal 409, into which the sleeve 421 is embedded at least in some sections, due to embedding in an electrically nonconducting material 423, which does, however, preferably have good heat conduction. A specific positioning of the control and/or regulating element 420 at a desired location in the electric heating device 400 is possible in this manner.

The connection area of the heating device 500, which is shown as a detail in FIG. 5, illustrates a variant of the arrangement of the control and/or regulating elements 503 at the heating element 502, which variant is applicable especially to the electric heating devices 100, 200, 300, 400 shown in FIGS. 1 through 4. The reference numbers used are correspondingly obtained from reference numbers used there by replacing the hundred digit by 5. The essential difference in this variant is that the sleeves 507 are adapted to the contour of the control and/or regulating elements 503, which can be achieved, for example, by a forming process. To nevertheless ensure an electrical insulation against the metal powder or granular metal 509, the sleeves 507 must, however, consists of an electrically insulating material.

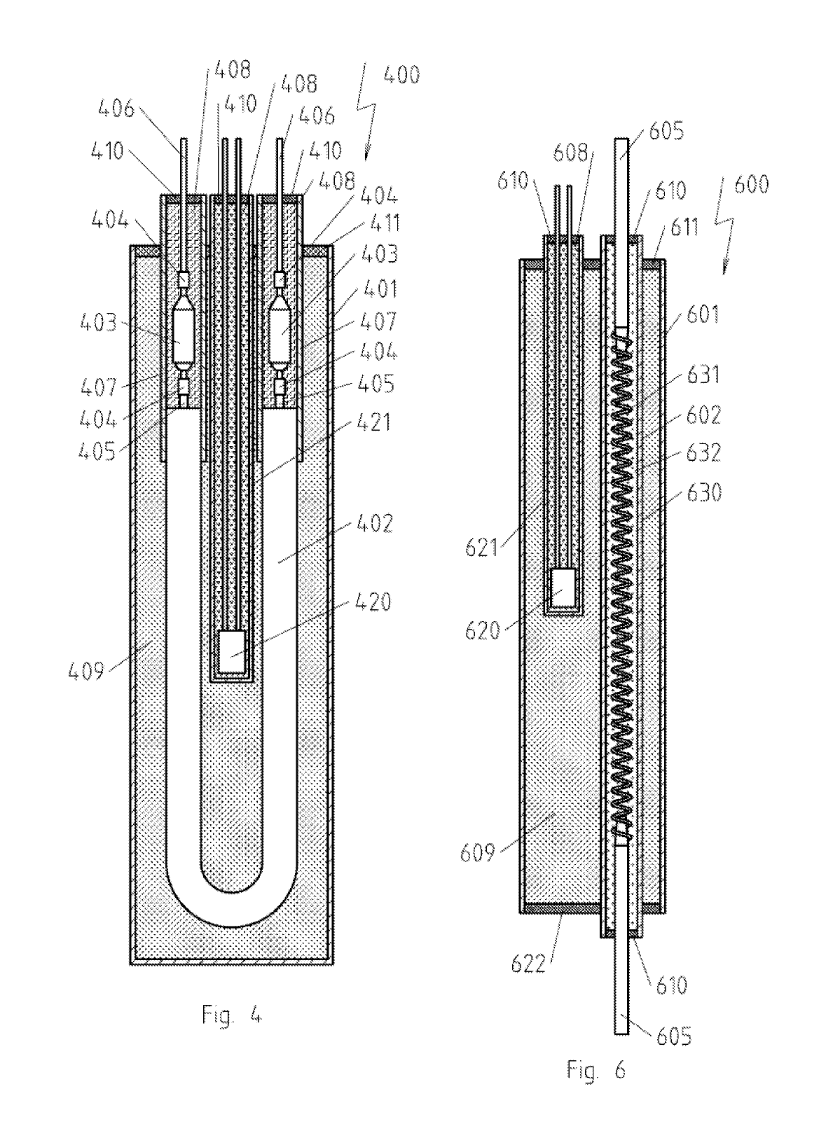

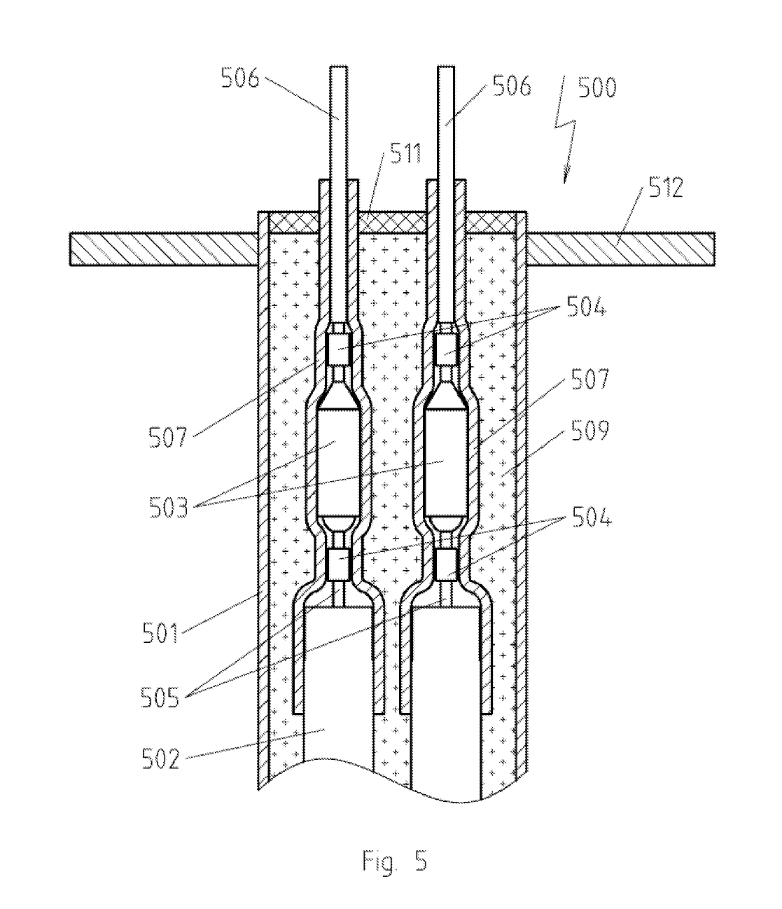

The exemplary embodiment of the electric heating device 600 according to FIG. 6 with tubular jacket surface 601, with the heating element 602, which passes through the electric heating device in the direction in which the latter extends, with the control and/or regulating element 620, with electric terminals 605, sleeve 621, MgO powder or granular MgO 608, metal powder or granular metal 609, closing plates 610, 611 and cover plate 612 as well as the bottom plate 622 differs from the exemplary embodiment according to FIG. 4 by the shape of the electric heating element 602, which is shown, moreover, cut open as an example in this view. As is seen in FIG. 6, the electric heating element 602 has a tubular jacket 630 with a heating wire coil 631, which is arranged in the interior space of said tubular jacket and which is held clamped between the electric terminals 605 and is embedded in compacted MgO powder or granular MgO 632.

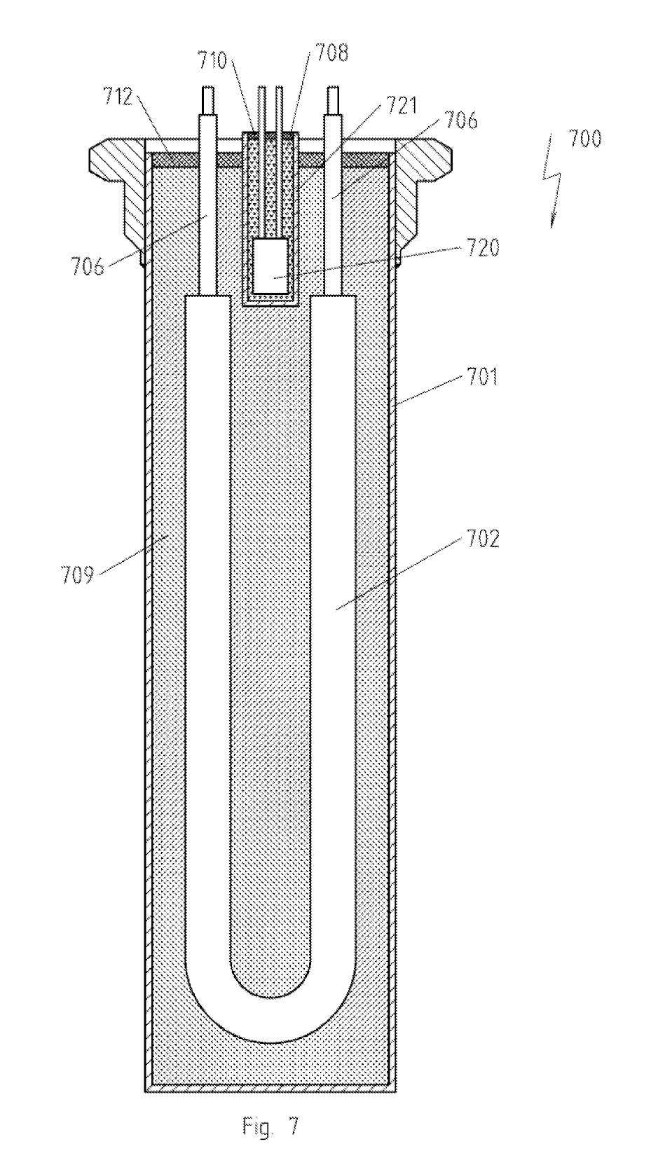

The exemplary embodiment of the heating device 700 according to FIG. 7 with tubular jacket surface 701, heating element 702 bent in a U-shaped pattern, control and/or regulating element 720, connection line 706, sleeve 721, MgO powder or granular MgO 708, metal powder or granular metal 709, closing plates 710 and cover plate 712 differs from the exemplary embodiment according to FIG. 4 in that no additional control and/or regulating elements are provided here at the connection lines 706 of the electric heating element 702.

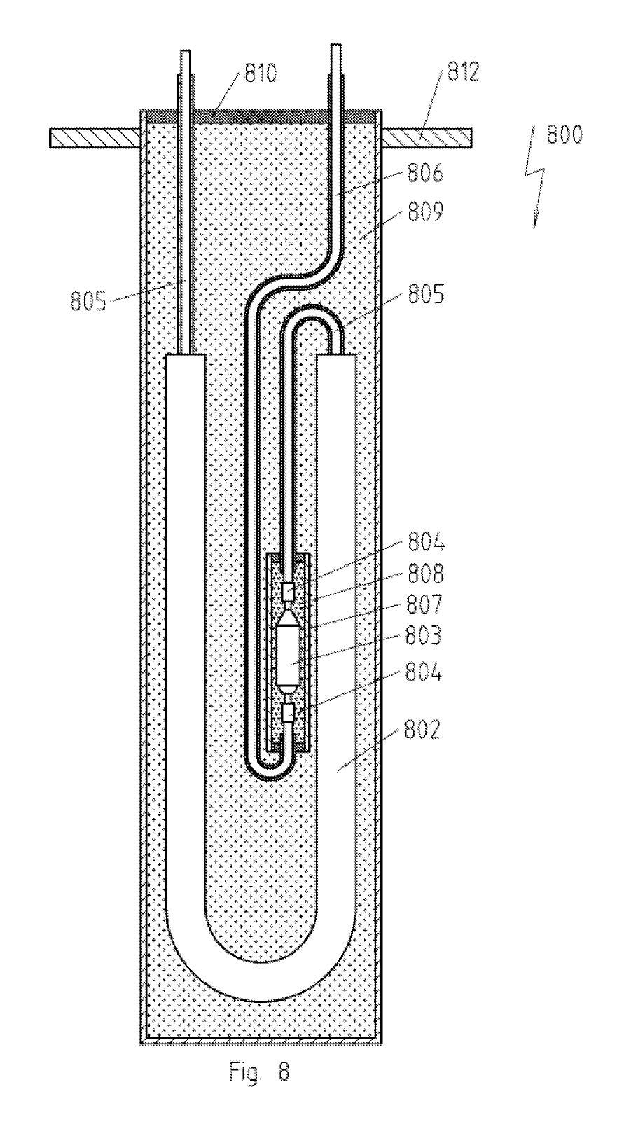

The exemplary embodiment of the heating device 800 according to FIG. 8 with tubular jacket surface 801, heating element 802 bent in a U-shaped pattern, control and/or regulating element 803, contact points 804, electric terminals 805, connection lines 806, sleeve 807, MgO powder or granular MgO 808, metal powder or granular metal 809, closing plate 810 and cover plate 812 shows a possibility, as an alternative to the exemplary embodiments according to FIGS. 4 and 7, for arranging the control and/or regulating element 803 in a desired position in the interior of the electric heating device 800. The electric terminal 805, at which the control and/or regulating element is arranged, is not led directly out of the electric heating device 800, but it extends first to the position at which the sleeve 807 with the control and/or regulating element 803, which is arranged therein insulated from the metal powder or granular metal 809, shall be arranged for monitoring, for example, the local temperature.

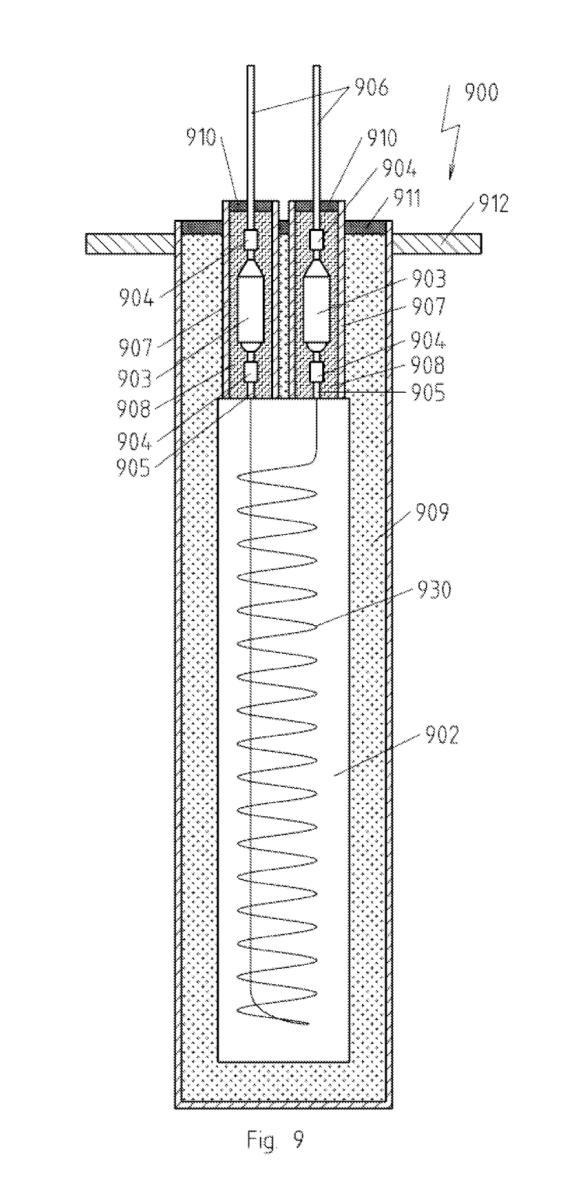

The exemplary embodiment of the heating device 900 according to FIG. 9 with the tubular jacket surface 901, heating element 902 in the form of a heating cartridge, in which heating cartridge the two ends of the heating wire coil 930 thereof—which heating wire coil is not actually visible because it is surrounded by the tubular jacket but is nevertheless drawn as a line for illustration—leave the tubular jacket on the same side; with control and/or regulating elements 903, contact points 904, electric terminals 905, connection lines 906, sleeves 907, MgO powder or granular MgO 908, metal powder or granular metal 909, closing plates 910, 911 and cover plate 912 illustrates that the electric heating element 902 may be configured such that it fills out essential parts of the interior space of the tubular jacket surface 901. This contributes to the possibility of achieving sufficiently good heat conduction even in case of large inner volumes of the tubular jacket surface 901 even at low compaction, because the electric heating element 902 can be provided separately and especially also in a compacted state.

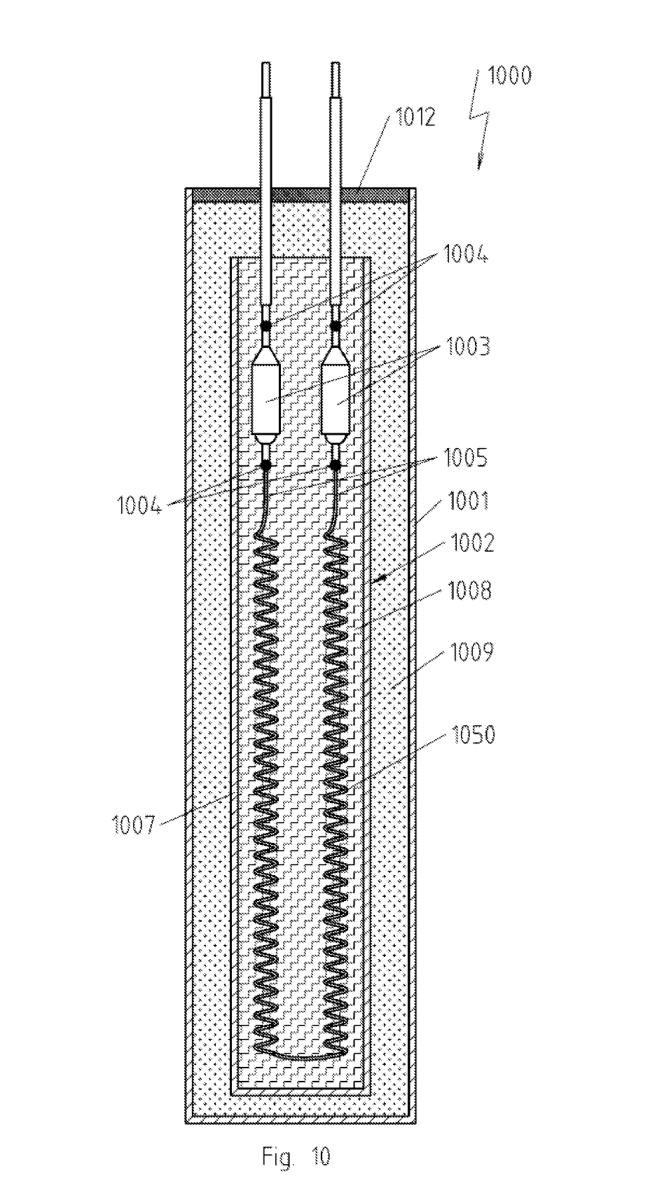

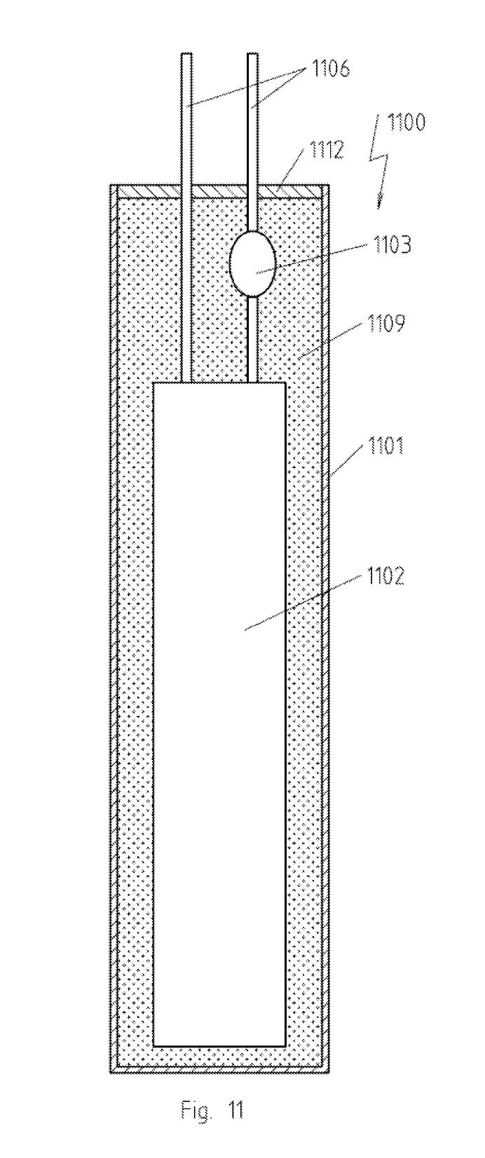

In the exemplary embodiment of the heating device 1000 according to FIG. 10 with tubular jacket surface 1001 with bottom, control and/or regulating elements 1003, contact points 1004, electric terminals 1005, connection lines 1006, electrically insulating powder or granular material 1008, which may especially be in the form of MgO powder or granular MgO, metal powder or granular metal 1009, and cover plate 1012, the electric heating element 1002 is formed by a heating cartridge, which is embedded in the metal powder or granular material 1009 and in the interior of which the control and/or regulating elements 1003 are integrated. The metal jacket of the electric heating element 1002 thus represents at the same time a sleeve 1007, which surrounds the control and/or regulating elements 1003 and in which these are embedded together with the heating wire coil 1050 of the electric heating element 1002 in the MgO powder or granular MgO 1008.

In the exemplary embodiment of the heating device 1100 according to FIG. 11 with tubular jacket surface 1101 with bottom, control and/or regulating element 1103, electric terminal 1105, connection lines 1106, metal powder or granular metal 1109, and cover plate 1112, the electric heating element 1102 is likewise formed by a heating cartridge embedded in the metal powder or granular metal 1109. However, the control and/or regulating element 1103 is configured here as an electrically insulating element against the area surrounding it, which can be achieved by extrusion coating with an electrically nonconducting material, so that direct embedding in the metal powder or granular metal 1109 can be carried out.

In addition, it should be noted that in all sectional views with the exception of FIGS. 6 and 10, the respective heating devices 100, 200, 300, 400, 500, 700, 800, 900, 1100 are shown with their cylindrical tube-shaped jacket surfaces 101, 201, 301, 401, 501, 701, 801, 901, 1101 cut open along their symmetry axes and with the electrically insulating powder or electrically insulating granular material 108, 208, 308, 408, 423, 508, 708, 808, 908, 1108 or metal powder or granular metal 109, 209, 309, 409, 509, 709, 809, 909, 1109 removed up to the section plane, and the control and/or regulating elements 103, 203, 303, 403, 420, 503, 720, 803, 903, 1103 and the heating elements 102, 202, 302, 312, 402, 502, 702, 802, 902, 1102 are shown as elements that are not cut open.

While specific embodiments of the invention have been shown and described in detail to illustrate the application of the principles of the invention, it will be understood that the invention may be embodied otherwise without departing from such principles.

### APPENDIX

### List of Reference Numbers

100, 200, 300, 400, 500, 600, 700, 800, 900, 1000, 1100 Heating device
101, 201, 301, 401, 501, 601, 701, 801, 901, 1001, 1101 Tubular jacket surface
102, 202, 302, 312, 402, 502, 602, 702, 802, 902, 1002, 1102 Heating element
103, 203, 303, 403, 420, 503, 620, 720, 803, 903, 1003, 1103 Control and/or regulating element
104, 204, 304, 404, 504, 804, 904, 1004 Contact point
105, 205, 305, 315, 405, 505, 605, 805, 905, 1005 Electric terminal
106, 206, 306, 316, 406, 506, 606, 706, 806, 906, 1006, 1106 Connection line
107, 207, 307, 407, 421, 507, 621, 721, 807, 907, 1007 Sleeve
108, 208, 308, 408, 608, 708, 808, 908, 1008 Electrically insulating powder or granular material
109, 209, 309, 409, 509, 609, 709, 809, 909, 1009, 1109 Metal powder or granular metal
110, 111, 210, 211, 311, 410, 411, 422, 610, 710, 810, 910, 911 Closing plate
112, 212, 317, 412, 512, 612, 712, 812, 912, 1012, 1112 Cover plate
622 Bottom plate
630 Tubular jacket
631, 1050 Heating wire coil

What is claimed is:

1. A heating device for fluids, the heating device comprising:
a tubular jacket surface formed of metal;
at least one heating element comprising a heating cartridge, a hollow cartridge, a tubular heating body or a coiled tube cartridge;
at least one control/regulating element comprising at least one control element or regulating element or both at least one control and regulating element for the at least one heating element, wherein the at least one heating element and the at least one control/regulating element are arranged at least partially within the tubular jacket surface; and
metal powder or granular metal within the tubular jacket surface, wherein the at least one heating element and the at least one control/regulating element are embedded at least partially in the metal powder or granular metal and the at least one control/regulating element is electrically insulated from the metal powder or granular metal.

2. A heating device in accordance with claim 1, wherein the at least one control/regulating element is electrically insulated from the metal powder or granular metal by the at least one control/regulating element being arranged within a sleeve, wherein the sleeve is arranged at least partially within the tubular jacket surface and is at least partially embedded in the metal powder or granular metal within the first jacket surface.

3. A heating device in accordance with claim 2, wherein the sleeve is adapted to a shape of the heating element such that it is in contact at least in some sections with a surface of the heating element, which is formed by the tubular jacket of the heating cartridge, of the hollow cartridge or of the coiled tube cartridge.

4. A heating device in accordance with claim 3, wherein:
the sleeve extends, at least in some sections, around the surface of the heating element; and
the surface of the heating element is formed by the tubular jacket of the heating cartridge, hollow cartridge or coiled tube cartridge.

5. A heating device in accordance with claim 1, wherein the at least one control/regulating element is configured as a fuse, platinum measuring resistor, NTC, bimetallic release or as any combination of a fuse, platinum measuring resistor, NTC and bimetallic release.

6. A heating device in accordance with claim 2, wherein the sleeve is adapted to an outer contour of the control/regulating element at least in some sections.

7. A heating device in accordance with claim 1, wherein the heating device is uncompacted.

8. A heating device in accordance with claim 1, wherein in an axial direction of the heating device, the heating device has at least one section in which the cross section through the tubular jacket extends through both compacted areas and uncompacted areas or through areas having different degrees of compaction.

9. A method for manufacturing an electric heating device comprising a tubular jacket surface formed of metal, at least one heating element, at least one control/regulating element comprising at least one control element or regulating element or both at least one control and regulating element for the at least one heating element, the method comprising the steps of:
providing the at least one heating element in the form of a heating cartridge, a hollow cartridge, a tubular heating body or a coiled tube cartridge;
providing the at least one control/regulating element such that the at least one control/regulating element is electrically insulated against an area surrounding the at least one control/regulating element;
positioning at least sections of the at least one heating element and positioning at least sections of the at least one control/regulating element in an interior of a tubular jacket surface; and
filling a remaining inner volume of the tubular jacket surface with a metal powder or granular metal.

10. A method in accordance with claim 9, wherein the control/regulating element is insulated against the area surrounding the control/regulating element by being arranged in the interior space of a sleeve such that the control/regulating element is electrically insulated against the outer sides of the sleeve.

11. A method in accordance with claim 10, wherein the control/regulating element is arranged in the interior space of the sleeve such that the control/regulating element is electrically insulated against the outer sides of the sleeve and the electrically insulated sleeve is pulled over the control/regulating element and is subsequently deformed by a forming process such that the electrically insulated sleeve is adapted to an outer contour of the control/regulating element at least in some sections.

12. A method in accordance with claim 10, wherein the control/regulating element, which is arranged in the interior space of a sleeve such that the control/regulating element is electrically insulated against the outer sides of the sleeve with the control/regulating element being arranged in the interior space of the sleeve and the remaining interior space then being filled with electrically insulating powder or granular material.

13. A method in accordance with claim 10, wherein the control/regulating element, which is arranged in the interior space of a sleeve such that the control/regulating element is electrically insulated against the outer sides of the sleeve, is provided by the control/regulating element being arranged in the interior space of the sleeve and the remaining interior space then being filled with a casting compound in the form of epoxy resin or silicone rubber.

14. A method in accordance with claim 9, wherein prior to positioning in the interior of the metal tubular jacket surface, the electrical connection is established between the corresponding electric terminal and the control/regulating element.

15. A method in accordance with claim 14, wherein the electrical connection is established, after which the sleeve is pulled over the control/regulating element and the remaining inner volume of the sleeve is subsequently to be minimized either by deforming the sleeve or by filling with an electrically insulating material in order to thus arrange the control/regulating element in the interior space of a sleeve electrically insulated from the outer side of the sleeve in conjunction with the electric heating element.
